(19) United States
(12) Patent Application Publication
(10) Pub. No.: US 2012/0086870 A1
(43) Pub. Date: Apr. 12, 2012

(54) REMOTE CONTROLLER SETTING MODULE, TELEVISION AND REMOTE CONTROL COMMAND SETTING METHOD THEREOF

(75) Inventor: HWAI-CHIH LEE, NEW TAIPEI CITY (TW)

(73) Assignees: KINPO ELECTRONICS, INC., New Taipei City (TW); CAL-COMP ELECTRONICS & COMMUNICATIONS COMPANY LIMITED, New Taipei City (TW)

(21) Appl. No.: 13/097,292

(22) Filed: Apr. 29, 2011

(30) Foreign Application Priority Data
Oct. 6, 2010 (TW) 99134070

(51) Int. Cl. H04N 5/44; G08C 19/16; H04B 10/00

(52) U.S. Cl. 348/734; 398/106; 340/12.24; 348/E05.096

(57) ABSTRACT

A remote control setting module which is suitable to be installed in an electronic apparatus to set a button command corresponding to a remote control signal from a remote controller is disclosed. The remote control setting module includes an infrared sensing unit and a signal processing unit. The infrared sensing unit receives the remote control signal from the remote controller and then identifies a signal waveform corresponding to remote control signal. The signal processing unit is coupled to the infrared sensing unit and used for setting the button command to correspond to the received signal waveform.

### BACKGROUND OF THE INVENTION

1. Field of the Invention

The present invention relates to a receiving module in an infrared remote controller; in particular, to a remote controller setting module, electronic device and remote control command setting method thereof.

2. Description of Related Art

The wavelength of infrared is between microwave and visible light which ranges from about 770 nm to approximately 1 mm. As the way it is referenced, infrared is located outside of red light on the optical spectrum, demonstrating significant thermal effects and easily absorbed by objects, thus usually applied as a heat source. Infrared is comprehensively employed in various fields, such as communication, detection, medical care, military and so forth. In people's daily lives, it is commonly utilized as an infrared remote controller for a television.

There exists a lot of infrared encoding and decoding methods, and currently available products using remote controller may take different coding/decoding (codec) approaches, so the remote controller thereof can not be shared. Hence, in case a user unfortunately lost the remote controller, he/she would have to search for it with great efforts; nevertheless, after a long duration of time, if the remote controller has never been found or become permanently lost, the entire product might be inoperable. Since the codec method adopted by each company differs, the remote controller specifically designed for each type of electronic devices can not interchangeable, undesirably leading to great inconvenience for numerous end-users.

### SUMMARY OF THE INVENTION

The objective of the present invention is to provide a remote controller setting module, television and remote control command setting method thereof. The remote controller setting module of the present invention can be applied to an electronic device thereby allowing a user to reconfigure the electronic device in order to identify the button command of different remote controllers. In accordance with the signal waveform of the remote control signal, the remote controller setting module can set the corresponding button command thereby identifying the remote control signal emitted by different remote controllers. Therefore, the user is capable of operating the electronic device with any type of remote controller through the setting procedure.

An embodiment of the present invention is directed to a remote controller setting module suitable for installation inside an electronic device thereby setting a button command according to a user's operation so as to correspond to a remote control signal emitted by a remote controller, in which the remote controller setting module comprises an infrared sensing unit and a signal processing unit. The infrared sensing unit is used to receive a remote control signal emitted by the remote controller and identify a corresponding signal waveform of the remote control signal. The signal processing unit is coupled to the infrared sensing unit and used for setting the button command to correspond to the received signal waveform.

Another embodiment of the present invention is directed a television suitable for receiving a remote control signal emitted by a remote controller, in which the television comprises a body and a remote controller setting module installed therein. The body has a screen. The remote controller setting module is installed inside the body for setting a button command so as to correspond to the remote control signal emitted by the remote controller. The remote controller setting module comprises an infrared sensing unit and a signal processing unit. The infrared sensing unit is used to receive a remote control signal emitted by the remote controller and identify a corresponding signal waveform of the remote control signal. The signal processing unit is coupled to the infrared sensing unit and used for setting the button command to correspond to the signal waveform.

Yet another embodiment of the present invention is directed a remote control command setting method suitable for setting a button command so as to correspond to a remote control signal emitted by a remote controller, in which the setting method comprises the following steps: (a) providing a user interface; (b) requiring to press down a button so as to generate a remote control signal; (c) identifying a corresponding signal waveform of the remote control signal, after sensing the remote control signal; (d) presenting a menu to a user through the user interface in order to select thereon the button command corresponding to the signal waveform; and (e) setting and saving the corresponding relationship between the signal waveform and the button command based on the user's operation.

In summary of aforementioned general illustrations, the remote controller setting module according to the present invention allows to reconfigure the corresponding button command based on the signal waveform of the remote control signal thereby allowing the electronic device to be controlled by any type of remote controller. In addition, since the remote controller setting module performs the identification directly according to the signal waveform of the remote control signal, the encoding and decoding methods of the remote control signal hence need no longer to be considered.

In order to better understand the above-said characteristics and advantages of the present invention, certain preferred embodiments thereof, along with appended drawings, are provided as below thereby enabling further detailed descriptions of the present invention.

### BRIEF DESCRIPTION OF THE DRAWINGS

FIG. 1 shows a functional block diagram of a remote controller setting module according to a first embodiment of the present invention;

FIG. 2 shows a functional block diagram of the signal processing unit 120 according to the first embodiment of the present invention;

FIG. 3 shows a functional block diagram of the signal processing unit according to another embodiment of the present invention;

FIG. 4 shows a diagram of a television according to the first embodiment of the present invention; and

FIG. 5 shows a flowchart of the remote control command setting method according to a second embodiment of the present invention.

### DETAILED DESCRIPTION OF THE PREFERRED EMBODIMENTS

### First Embodiment

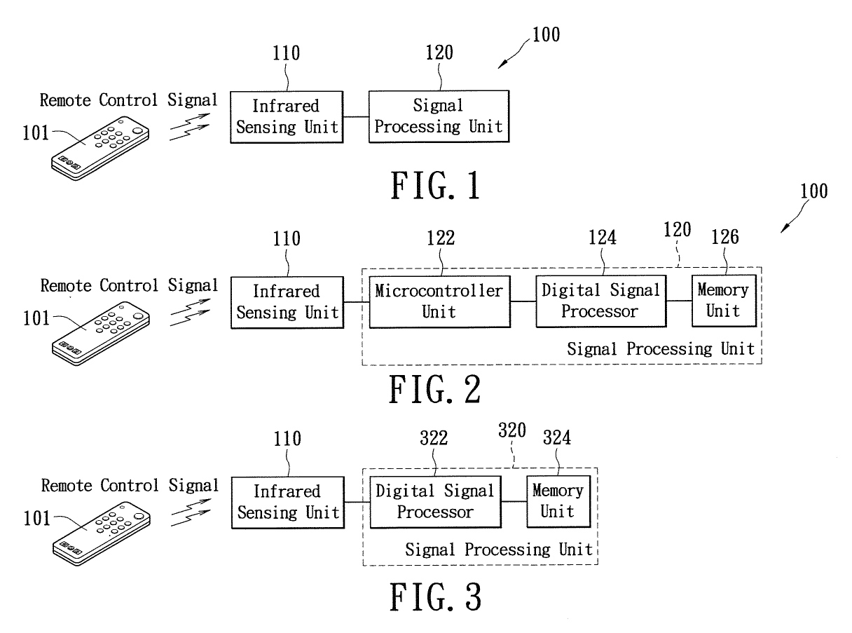

FIG. 1 shows a functional block diagram of a remote controller setting module according to a first embodiment of the present invention. Herein the remote controller setting module 100 comprises an infrared sensing unit 110 and a signal processing unit 120. The infrared sensing unit 110 is used to receive a remote control signal emitted by a remote controller 101 and identify the signal waveform corresponding to such a remote control signal. The signal processing unit 120 is coupled to the infrared sensing unit 110 and used to set the button command of the waveform corresponding to the remote control signal. In the present embodiment, the remote controller 101 can be, for example, an infrared remote controller, the remote control signal thereby emitted can be an infrared signal generated as a button on the remote controller 101 being pressed down.

The infrared sensing unit 110 can be implemented by using the infrared receiver diode or photo-transistor. A serial connection of the infrared receiver diode with the resistor can constitute a simple infrared sensing circuit which converts an infrared signal into a voltage waveform for subsequent identification processes. After converting the infrared signal into the voltage waveform, the infrared sensing unit 110 is able to identify the corresponding signal waveform (presented in a form of voltage) for the infrared signal (remote control signal). The infrared sensing unit 110 can use a time-division sampling approach to identify the entire signal waveform. A general infrared receiving module uses such a signal waveform to decode so as to extract the data carried by the infrared signal. In other word, such a signal waveform corresponds to the data intended to be transferred by the infrared signal.

After identification of the waveform of the infrared signal by the infrared sensing unit 110, the signal processing unit 120 provides a user interface through the screen of the electronic device thereby allowing the user to set the button command corresponding to such a signal waveform and save the corresponding relationship between such a signal waveform and the button command. For example, when the user presses down the numeral button “1” on the remote controller 101, the remote controller 101 emits a signal waveform corresponding to the numeral button “1”. After acquiring the signal waveform, the signal processing unit 120 displays a corresponding user interface on the screen of the electronic device thereby allowing the user to set the button command to which the signal waveform corresponds. If the user selects the numeral button “1”, then the signal processing unit 120 records that the signal waveform corresponds to the numeral button “1”. By means of this setting process, the signal processing unit 120 is able to obtain the relationship between other buttons and corresponding signal waveforms. Upon completion of this setting process, the user can operate this remote controller 101 to communicate with the remote controller setting module 100.

The remote controller setting module 100 can be directly installed within, or integrated into, the electronic device such as television, Hi-Fi stereo or any digital home appliances, and the present invention is by no means limited thereto. The electronic device can apply the remote controller setting module 100 to build dedicated communication protocols with any kind of infrared remote controller, and such communication protocols are only in relation with the signal waveform but completely irrelevant to the original codec method. That is, by means of the remote controller setting module 100, the user is able to use any kind of infrared remote controller to operate the electronic device.

Furthermore, it should be noted that the signal processing unit 120 can be implemented in several ways. Refer next to FIG. 2, wherein a functional block diagram of the signal processing unit 120 according to the first embodiment of the present invention is shown. The signal processing unit 120 includes a microcontroller unit 122, a digital signal processor 124 and a memory unit 126. The microcontroller unit (MCU) 122 is coupled to the infrared sensing unit 110 for recording the corresponding signal waveform of the remote control signal. The digital signal processor (DSP) 124 is coupled to the MCU 122 for setting the button command. The memory unit 126 is coupled to the DSP 124 so as to store the corresponding relationship between the signal waveform and the button command. Herein the MCU 122 can be a microcontroller of, for example, type number 8051, 8052 manufactured by Intel Inc. The DSP 124 can be also embodied by the microprocessor configured inside the television. In addition, the memory unit 126 may be a non-volatile memory (NVRAM); i.e., ROM and Flash memory. Whereas it should be appreciated that the circuit implementations constituting the present invention are by no means limited to those above-mentioned components, and other elements enabling equivalent or similar functions can be applied as well.

Refer to FIG. 3, which shows a functional block diagram of the signal processing unit according to another embodiment of the present invention. The signal processing unit 320 includes a digital signal processor 322 and a memory unit 32, in which the memory unit 324 is coupled to digital signal processor 322. Since the digital signal processor 322 has powerful functions, which can be used to replace the microcontroller unit 122 and digital signal processor 124 as shown in FIG. 2 to save the corresponding waveform of the remote control signal and set the corresponding button command.

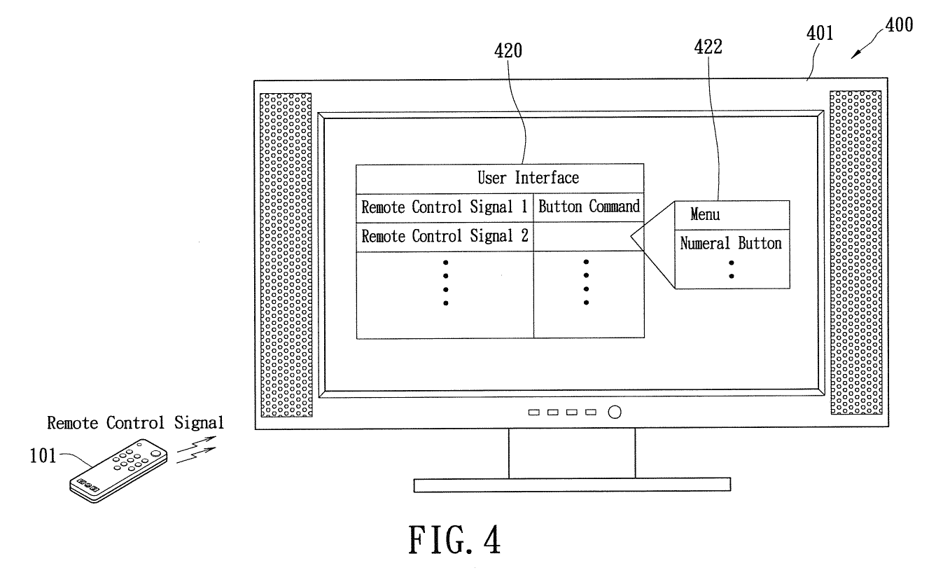

Refer then to FIG. 4 wherein a diagram of a television according to the first embodiment of the present invention is shown. An above-said remote controller setting module 100 (not shown) is installed inside the body 401 of the television 400. When a user activates the remote controller setting function of the remote controller setting module 100, the signal processing unit 120 in the remote controller setting module 100 provides the user with a user interface 420 through the screen of the electronic device 400 and allows the user to set the button command. The signal processing unit 120 initially asks the user to press down a button on the remote controller 101. After reception of a remote control signal, the remote controller setting module 100 identifies the signal waveform to which the remote control signal corresponds and then provides the user with a menu 422 to set the corresponding button command; e.g., a channel button, a numeral button, a function button or a volume button and the like. After selection of the corresponding button command by the user, the signal processing unit 120 saves the corresponding relationship between the signal waveform and the button command.

The user can apply such a setting process to configure each button on the remote controller 101 one by one such that the television 400 is enabled to identify the corresponding button command in accordance with the signal waveform emitted by the remote controller 101. After acquisition of the corresponding relationship between all button commands and signal waveforms, the remote controller setting module 100 can correctly determine the button which the user presses down on the remote controller directly based on the received signal waveform and then execute the corresponding button command. Since the remote controller setting module 100 directly applies the signal waveform emitted by the remote controller 101 to perform the identification process, it needs not to specifically take the codec method used by the remote controller 101 into consideration. Also, during the identification of the signal waveform sent by the remote controller 101, the remote controller setting module 100 is not required to decode the signal waveform thereof at all.

It can be seen from aforementioned descriptions that, by using the remote controller setting module 100 according to the present invention, the electronic device can be reconfigured anytime to decode the signal waveform coming from the remote controller such that the user is able to use different remote controllers to control the electronic device. Besides, it should be noted that the above-said signal waveform can be converted into a digital signal for storage. The signal waveform and the button command can be saved in the memory unit 126 in a way of lookup table as well, and the present invention is not limited to such approaches. The aforementioned television 400 indicates merely one embodiment of the present invention, the remote controller setting module 100 can be applied on a variety of electronic devices, such as a Hi-Fi stereo, an air-conditioner etc., and the present invention is not limited thereto.

### Second Embodiment

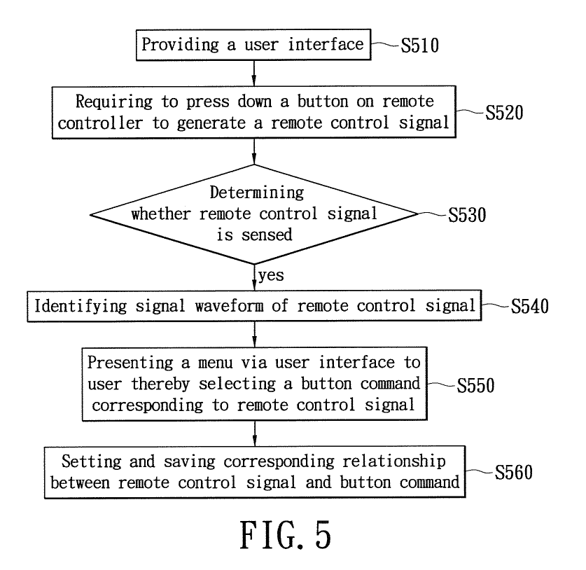

From the previously illustrated embodiment, a remote control command setting method can be deduced which is suitable for setting a button command to correspond to a remote control signal emitted by a remote controller. Refer collectively to FIGS. 1-5, and in particular FIG. 5 shows a flowchart of the remote control command setting method according to a second embodiment of the present invention which comprises the following steps: initially, providing a user interface (STEP S510), as shown in FIG. 4; next, presenting a prompt through the user interface to ask a user to press down a button on the remote controller so as to generate a remote control signal (i.e., an infrared signal) (STEP S520); subsequently, determining whether the remote control signal is sensed (STEP S530); if the remote control signal is sensed, then identifying the signal waveform of the received remote control signal (STEP S540); afterward, presenting a menu via the user interface to the user thereby selecting a button command corresponding to the remote control signal (that is, the sensed signal waveform) (STEP S550); and then, setting and saving the corresponding relationship between the remote control signal and the button command based on the output of the user (STEP S560).

In an embodiment of the present invention, the execution of STEP S520 to STEP S560 can be repeated in order to set for a plurality of different button commands. It should be noted that, in the aforementioned STEP S510 to STEP S560, the received remote control signal is never decoded. Other details in connection with the remote control command setting method according to the present invention can be clearly inferred by those skilled ones in the relevant art from the above-said first embodiment, which are herein omitted for brevity.

Furthermore, it should be noted the couplings between previously said components may be direct, indirect or both direct and indirect electrical connections, so long as the required electric signal transfer function can be effectively achieved, and the present invention is not limited thereto. The technical means in the aforementioned embodiments can be conjunctively or individually applied, whose components may be added, removed, adjusted or substituted in accordance with the feature and design requirement thereof, and the present invention is not limited thereto. Meanwhile, with reference to the descriptions of the aforementioned embodiments, those skilled ones in the relevant art should be able to infer the implementation approaches thereof which are herein omitted for brevity.

In summary, the remote controller setting module according to the present invention allows to set the button command directly based on the signal waveform thereby that the electronic device can be reconfigured to identify the remote control signal emitted by the remote controller. Accordingly, the user can apply different remote controllers to operate the electronic device.

It will be apparent to those skilled in the art that various modifications and variations can be made to the structure of the present invention without departing from the scope of the invention. In view of the foregoing, it is intended that the present invention cover modifications and variations of this invention provided they fall within the scope of the following claims and their equivalents.

What is claimed is:

1. A remote controller setting module suitable for installation inside an electronic device thereby setting a button command according to a user's operation so as to correspond to a remote control signal emitted by a remote controller, comprising:
an infrared sensing unit for receiving a remote control signal emitted by the remote controller and identifying a corresponding signal waveform of the remote control signal; and
a signal processing unit, coupled to the infrared sensing unit, for setting the button command to correspond to the received signal waveform.

2. The remote controller setting module according to claim 1, wherein the signal processing unit provides a user interface through a screen of the electronic device thereby allowing the user to set the button command and save the corresponding relationship between the signal waveform and the button command.

3. The remote controller setting module according to claim 1, wherein the infrared sensing unit uses a time-division sampling approach to extract the corresponding signal waveform of the remote control signal, and but sets the button command directly based on the signal waveform without decoding the remote control signal.

4. The remote controller setting module according to claim 1, wherein the signal processing unit comprises:
a microcontroller unit, coupled to the infrared sensing unit, for recording the corresponding signal waveform of the remote control signal;
a digital signal processor, coupled to the microcontroller unit, for setting the button command; and
a memory unit, coupled to the digital signal processor, for saving the corresponding relationship between the signal waveform and the button command.

5. The remote controller setting module according to claim 1, wherein the signal processing unit comprises:
a digital signal processor, coupled to the infrared sensing unit, for setting the button command; and
a memory unit, coupled to the digital signal processor, for saving the corresponding relationship between the signal waveform and the button command.

6. The remote controller setting module according to claim 1, wherein the remote control signal is an infrared signal generated upon pressing down a button on the remote controller, and the button command corresponds to the button.

7. A television suitable for receiving a remote control signal emitted by a remote controller, comprising:
a body having a screen; and
a remote controller setting module, installed inside the body, for setting a button command to correspond to the remote control signal emitted by the remote controller, which remote controller setting module comprising:
an infrared sensing unit for receiving the remote control signal emitted by the remote controller and identifying a corresponding signal waveform of the remote control signal; and
a signal processing unit, coupled to the infrared sensing unit, for setting the button command to correspond to the signal waveform.

8. The television according to claim 7, wherein the signal processing unit provides a user interface through the screen of the electronic device thereby allowing the user to set the button command and save the corresponding relationship between the signal waveform and the button command.

9. The television according to claim 7, wherein the infrared sensing unit uses a time-division sampling approach to extract the corresponding signal waveform of the remote control signal, and the signal processing unit sets the button command directly based on the corresponding signal waveform of the remote control signal without decoding the remote control signal.

10. The television according to claim 7, wherein the signal processing unit comprises:
a microcontroller unit, coupled to the infrared sensing unit, for recording the waveform of the remote control signal;
a digital signal processor, coupled to the microcontroller unit, for setting the button command; and
a memory unit, coupled to the digital signal processor, for saving the corresponding relationship between the signal waveform and the button command.

11. The television according to claim 7, wherein the signal processing unit comprises:
a digital signal processor, coupled to the infrared sensing unit, for setting the button command; and
a memory unit, coupled to the digital signal processor, for saving the corresponding relationship between the signal waveform and the button command.

12. The television according to claim 7, wherein the remote control signal is an infrared signal generated upon pressing down a button on the remote controller.

13. A remote control command setting method suitable for setting a button command according to a user's operation to correspond to a remote control signal emitted by a remote controller, comprising:
(a) providing a user interface;
(b) presenting a prompt in order to require to press down a button on the remote controller so as to generate the remote control signal;
(c) identifying a corresponding signal waveform of the remote control signal after sensing the remote control signal;
(d) presenting a menu to a user through the user interface in order to select thereon the button command corresponding to the signal waveform; and
(e) setting and saving the corresponding relationship between the signal waveform and the button command based on the user's operation.

14. The remote control command setting method according to claim 13, wherein the remote control signal is an infrared signal generated upon pressing down the button on the remote controller, and the button command corresponds to the button.

15. The remote control command setting method according to claim 13, further comprising repeatedly executing STEP (b) to STEP (e) in order to set for a plurality of different button commands.

16. The remote control command setting method according to claim 13, wherein, in STEP (a) to STEP (e), the received remote control signal is never decoded.
